(19) United States
(12) Patent Application Publication
(10) Pub. No.: US 2026/0030489 A1
(43) Pub. Date: Jan. 29, 2026

(54) ARTIFICIAL INTELLIGENCE AGENT ASSIST

(71) Applicant: Avaya Management L.P., Morristown, NJ (US)

(72) Inventor: Thomas Joseph Moran, Castlerea (IE)

(21) Appl. No.: 18/785,240

(22) Filed: Jul. 26, 2024

(51) Int. Cl. G06N 3/0475; G10L 13/047; G10L 15/06; G10L 15/16; G10L 21/034; H04M 3/51

(52) U.S. Cl. CPC G06N 3/0475; G10L 13/047; G10L 15/063; G10L 15/16; G10L 21/034; H04M 3/5166

(57) ABSTRACT

Systems and methods are provided to determine when a communication, such as a communication between a customer and an agent, comprises automatable content. The automatable content may comprise routine but voluminous information (e.g., “boilerplate”), which may require customizations targeted to the customer, and/or portions of the communication that the agent does not need to hear (e.g., tangents, swearing, etc.). An artificial intelligence (AI) agent is provided with speech and/or visual attributes of the agent and continues the communication with the customer, allowing the customer to continue without unnecessarily wasting computational and networking resources and/or unnecessarily exposing the agent to the customer's hostility or other unnecessary portions of the communication.

### FIELD OF THE DISCLOSURE

The invention relates generally to systems and methods for automating portions of a communication and particularly to determining when a communication comprises automatable content and providing an artificial intelligence (AI) to conduct the communication as a proxy for the live agent.

### BACKGROUND

Customers interact with contact centers to perform a variety of features, such as to get or provide information, make purchases, change reservations, and so on. When a customer is displeased with a company's goods or services, the contact center agent is often the recipient of the customer's anger and frustration. Agents are tasked with sorting out the customer's issues and providing a resolution as best they can. However, agents are human, and the agent's performance can be severely impacted due to increased stress levels as a result of dealing with problematic customers.

### SUMMARY

Allowing a communication between a customer and an agent to be conducted normally, as perceived by the customer, but without exposing the agent to non-productive portions of the communication would allow agents to focus on the issue at hand, such as a work item to address the customer's needs. The non-productive portions may include receiving vitriol or other hostile or offensive words (either voice via audio or text via text chat) or visual expressions (video images via video chat) that do little to allow the agent to determine the issue and provide a resolution. Similarly, a customer may have a question that requires a lengthy response, which may have location-specific or other nuance, that requires the agent to be attentive and thorough even though the content may be tedious (e.g., explaining terms of an agreement, which may have product specific or state or other location-specific modifications).

These and other needs are addressed by the various embodiments and configurations of the present invention. The present invention can provide a number of advantages depending on the particular configuration. These and other advantages will be apparent from the disclosure of the invention(s) contained herein.

In one embodiment, an artificial intelligence (AI) agent is deployed to monitor a communication between an agent and a customer over a network. The AI agent may then determine that the communication content (e.g., words, phrases, topics, etc.) comprise automatable content. The automatable content may receive the customer's hostile words while patiently prompting the customer to discuss the core issue and/or allow the agent to help as best that they are able to. The AI agent may take over the communication with the (human) agent's own characteristics (e.g., intonation, pattern of speech, accent, etc.) so that the AI agent provides the customer with what appears to be the same agent.

In another embodiment, the AI agent may be manually triggered, such as by the agent or automatically, such as by the AI agent detecting the communication is, or is about to, comprise automatable content. For example, if the customer is ranting, the AI agent may determine that the communication content comprises automatable content (e.g., receive the hostile or other irrelevant content) and take over the communication from the human agent. Similarly, if the communication between the customer and the human agent foreshadows automatable content (e.g., “Let me tell you about the ‘right to repair’ laws in your state,” “What does a subrogation clause mean?”, etc.).

In another embodiment, the human agent may remain connected to the communication, such as to monitor the exchange and take over if the AI agent is failing to perform as expected. Such an intervention may be provided back to the AI agent as a training input. Additionally or alternatively, the AI agent may present text or (whisper) audio to the human agent to get permission to take an action or to resolve any confusion the AI agent may have. For example, the human agent may be presented with an option (e.g., “Option 1—Offer a full refund if they return the item. Option 2—Offer a 25% discount on a replacement item, and they can keep the original item . . . please select one”) to select or an open-ended question (e.g., “How should I resolve this?”), to which the human agent may briefly reply (“Offer 25% off, but if they are still angry, make it 50%, but no more.”).

While in some embodiment, the human agent observes the communication between the AI agent and the customer, in other embodiments, the agent may be released from the communication. When released from the communication, the agent's device may be connected to another customer and thereby reduce the number of connections and agent devices and the associated networking and computer components that would otherwise be required if the agent were idle during the AI agent's interaction with the customer.

In some aspects, the techniques described herein relate to a method, including:
monitoring, by a microprocessor, a communication, via a network, between a customer device and an agent device including communication content, the communication content further including an agent portion provided by an agent via the agent device and a customer portion provided by a customer via the customer device; upon determining, by the microprocessor monitoring the communication, that the communication includes automatable content, generating automated content; and presenting the automated content as the agent portion of the communication to the customer.

In some aspects, the techniques described herein relate to a method, wherein determining that the communication includes automatable content, further includes determining that the communication includes offensive language within the customer portion of the communication.

In some aspects, the techniques described herein relate to a method, further including: a data storage including a number of records, wherein at least one of the number of records maintains attributes of the agent; and accessing the number of data records; and wherein determining that the communication includes offensive content within the customer portion of the communication further includes determining that at least one of the attributes of the offensive content exceeds at least one of the attributes of the agent.

In some aspects, the techniques described herein relate to a method, wherein determining that the communication includes automatable content, further includes determining that the communication includes offensive content for the agent.

In some aspects, the techniques described herein relate to a method, wherein generating automated content including speech attributes of the agent further includes generating automated content including speech attributes of one of the agent or another agent different from the agent.

In some aspects, the techniques described herein relate to a method, wherein determining that the communication includes automatable content further includes, providing the communication to a neural network trained to determine automatable content.

In some aspects, the techniques described herein relate to a method, wherein the neural network is trained including: collecting a set of prior communications from a database; applying one or more transformations to each prior communication of the set of prior communications including adding banter, removing banter, replacing a word with a synonym, increasing spoken volume, decreasing spoken volume, increasing rate of speech, decreasing the rate of speech, adding emotional vocal intonations, removing emotional vocal intonations, inserting a question, and removing a question to create a modified set of prior communications; creating a first training set including the collected set of prior communications, the modified set of prior communications, and a set of non-automatable content; training the neural network in a first stage using the first training set; creating a second training set for a second stage of training including the first training set and non-automatable content incorrectly determined as automatable content after the first stage of training; and training the neural network in the second stage using the second training set.

In some aspects, the techniques described herein relate to a method, wherein determining that the communication includes automatable content further includes, generating a prompt including the communication, a set of past communications including automatable content, a set of past communications including non-automatable content, and a request to identify automatable content in the communication; and providing the prompt to an artificial intelligence and receiving the automatable content therefrom.

In some aspects, the techniques described herein relate to a method, wherein presenting the automated content as the agent portion of the communication to the customer further includes muting, by the microprocessor, an audio input portion of the agent device that receives speech from the agent.

In some aspects, the techniques described herein relate to a method, further including: a database including a document record; and wherein generating automated content further includes generating a script including the document record.

In some aspects, the techniques described herein relate to a method, wherein: the database further includes a customer attribute of the customer; and wherein the document record further includes a document record associated with the customer attribute.

In some aspects, the techniques described herein relate to a system, including: a network interface to a network; at least one microprocessor coupled to a computer memory including instructions that, when read by the microprocessor, cause the microprocessor to perform: monitoring a communication, via a network, between a customer device and an agent device including communication content, the communication content further including an agent portion provided by an agent via the agent device and a customer portion provided by a customer via the customer device; upon determining that the communication includes automatable content, generating automated content; and presenting the automated content as the agent portion of the communication to the customer.

In some aspects, the techniques described herein relate to a system, wherein determining that the communication includes automatable content, further includes determining that the communication includes offensive language within the customer portion of the communication.

In some aspects, the techniques described herein relate to a system, further including: a data storage including a number of records, wherein at least one of the number of records maintains attributes of the agent; and wherein the microprocessor further performs: accessing the number of data records; and determining that the communication includes offensive content within the customer portion of the communication further including determining that at least one of the attributes of the offensive content exceeds at least one of the attributes of the agent.

In some aspects, the techniques described herein relate to a system, wherein determining that the communication includes automatable content, further includes determining that the communication includes offensive content for the agent.

In some aspects, the techniques described herein relate to a system, wherein generating automated content including speech attributes of the agent further includes generating automated content including speech attributes of one of the agent or another agent different from the agent.

In some aspects, the techniques described herein relate to a system, wherein determining that the communication includes automatable content further includes, providing the communication to a neural network trained to determine automatable content.

In some aspects, the techniques described herein relate to a system, wherein the neural network is trained, including: at least one microprocessor coupled to the computer memory including instructions to cause the at least one microprocessor, upon reading the instructions, to perform: collecting a set of prior communications from a database; applying one or more transformations to each prior communication of the set of prior communications including adding banter, removing banter, replacing a word with a synonym, increasing spoken volume, decreasing spoken volume, increasing rate of speech, decreasing the rate of speech, adding emotional vocal intonations, removing emotional vocal intonations, inserting a question, and removing a question to create a modified set of prior communications; creating a first training set including the collected set of prior communications, the modified set of prior communications, and a set of non-automatable content; training the neural network in a first stage using the first training set; creating a second training set for a second stage of training including the first training set and non-automatable content incorrectly determined as automatable content after the first stage of training; and training the neural network in the second stage using the second training set.

In some aspects, the techniques described herein relate to a system, wherein determining that the communication includes automatable content further includes, generating a prompt including the communication, a set of past communications including automatable content, a set of past communications including non-automatable content, and a request to identify automatable content in the communication; and providing the prompt to an artificial intelligence and receiving the automatable content therefrom.

In some aspects, the techniques described herein relate to a computer-readable medium including instructions to cause a microprocessor to perform: monitoring a communication, via a network, between a customer device and an agent device including communication content, the communication content further including an agent portion provided by an agent via the agent device and a customer portion provided by a customer via the customer device; upon determining that the communication includes automatable content, generating automated content; and presenting the automated content as the agent portion of the communication to the customer.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure;

FIG. 4 depicts a process in accordance with embodiments of the present disclosure; and

FIG. 5 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

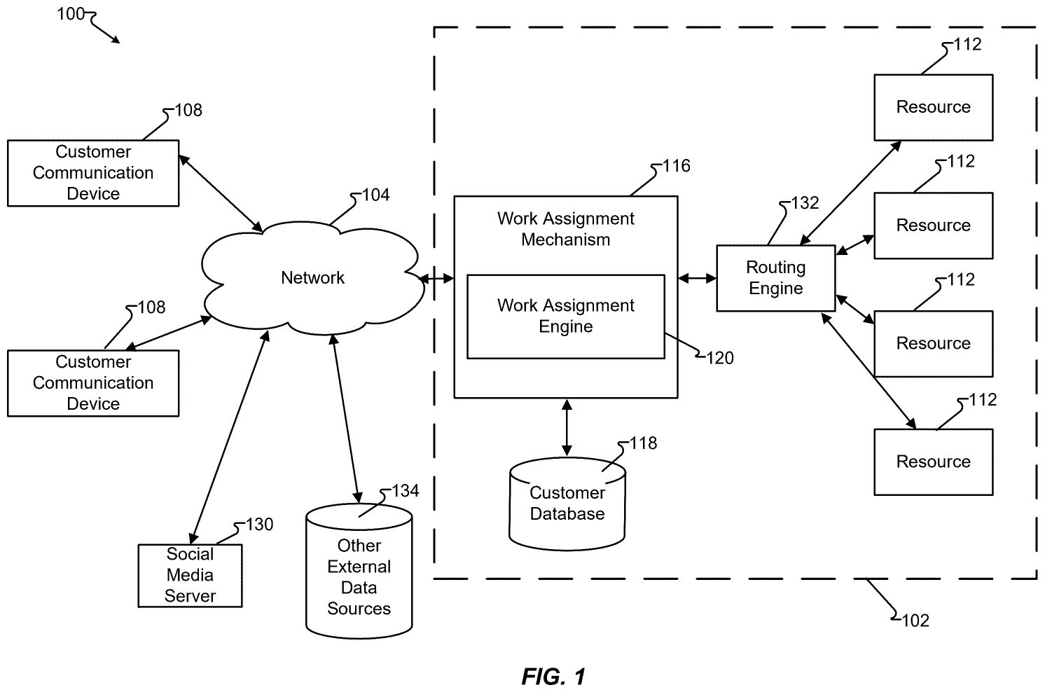

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., a company, an enterprise, etc.), and/or a logical boundary (e.g., resources 112 utilized to provide services to customers of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., a VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., a WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VOIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Pat. No. 8,964,958 issued on Feb. 24, 2015 to Steiner, the entire contents of which are hereby incorporated herein by reference. Moreover, the communication network 104 may comprise a number of different communication media, such as a coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., a collection of servers), a media request, an application request (e.g., a request for application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. No. 8,634,543 issued on Jan. 21, 2014, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

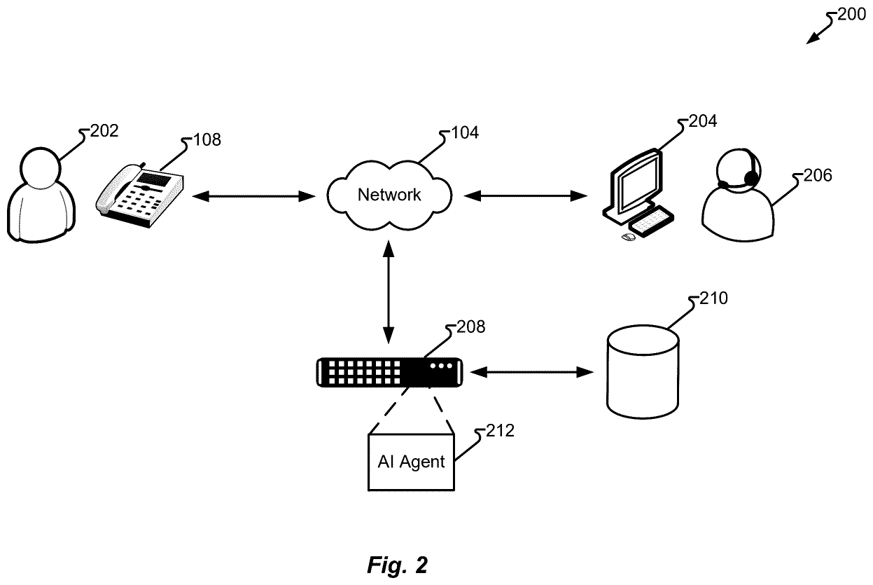

FIG. 2 depicts system 200 in accordance with embodiments of the present disclosure. System 200 illustrates components of system 100 wherein certain components are omitted to avoid unnecessarily complicating the figure and associated description. Those of ordinary skill in the art will appreciate that the topology illustrated in system 200 may be one configuration of the components and that other topologies may be implemented without departing from the scope of the embodiments.

In one embodiment, customer 202 utilizes customer communication device 108, via network 104, to communicate with agent 206 utilizing agent communication device 204. The communication may comprise audio (e.g., speech), text (e.g., text messages, text chat, etc.), and/or video (e.g., video conference/video chat). The communication content (e.g., words, phrases, topics, tone, volume, emotion indicators, etc.) is monitored by server 208.

In another embodiment, server 208 monitors the communication content of the communication for automatable content. Automatable content is variously embodied and, in one embodiment, comprises maintaining the communication when customer 202 is being hostile and providing offensive language (e.g., yelling, cursing, etc.), irrelevant information (e.g., providing extraneous details, etc.), or requesting boilerplate content. The boilerplate content may or may not be modified. For example, customer 202 may ask agent 206 to explain a routine, but involved topic, such as the general meaning of a subrogation clause. However, the content may require the selection of a particular boilerplate or the modification of a generic boilerplate, such as the meaning of the term specifically for the state in which customer 202 resides. The boilerplate provided may comprise content originated from a document record, such as may be maintained in database 210. The boilerplate may be the document verbatim, or one or more portions of the document, and/or paraphrasing the document.

For automatable content that is based on irrelevant content (e.g., hostile remarks, etc.) what is or is not irrelevant may be determined in absolute terms and/or attributes of agent 206. For example, customer 202 may be complaining and using a barrage of vulgarities. Server 208 monitors the communication, including the vulgarities, and accesses a record from database 210. For example, the database may comprise a record that scores vulgarities as well as a tolerance for vulgarities associated with agent 206. Agents (of which agent 206 is one) may have different tolerances for different vulgarities or other forms of non-productive speech based on their personal preferences and tolerances and/or demographic characteristics. When the offensive content within the communication is greater than the offensive content of at least one attribute of agent 206, then offensive, and therefore automatable, content is present. Otherwise the communication may be processed normally with agent 206.

When server 208 determines the communication comprises or is about to comprise automatable content, agent 206 may be removed from the communication (i.e., no longer providing audio and/or video) and, in place thereof, AI agent 212 continues the communication with customer 202. Server 208 may automatically mute an audio portion of the communication content originating from agent communication device 204, such as a microphone capturing speech from agent 206. Similarly, agent communication device 204 may capture a video image of agent 206 and similarly be discontinued while customer 202 is engaged with AI agent 212.

Agent 206 may continue monitoring the communication or be completely removed.

When agent 206 is removed from the communication, server 208 may allow agent communication device 204 to be connected to another communication with a different customer, such as another voice call or text chat. When server 208 determines the automatable content is about to end (e.g., the explanation of a subrogation clause is within thirty seconds of being finished), server 208 may cause a notification to be presented on agent communication device 204 and/or refuse any other communications with other customers. As a further option, server 208 may present agent communication device 204 with a summary of the automatable content and any questions, unusual comments, or other noteworthy statements made by customer 202. For example, “Customer was presented with subrogation laws for the home state of Massachusetts, but this may not apply to customer's vacation property in Delaware,” “Customer is angry about their lost luggage and not having proper clothes for a wedding and wedding pictures,” “Customer appears to understand the issue,” or “Customer is calm now.” As a benefit, agent 206 may then resume the conversation from AI agent 212 with relevant knowledge of the automated content (herein, “automated content” is “automatable content” that has been presented).

AI agent 212 may be configured, such as from a record maintained in database 210, with attributes of agent 206. As a result, customer 202 is presented with the same pattern of communication (e.g., speech, accent, word choice, visual appearance, etc.) even though they are communicating with AI agent 212. AI agent 212 may be trained to provide acknowledgement (e.g., “I see.” “I'm sorry that happened”, etc.) while customer 202 vents their anger and/or addresses specific questions that are known to AI agent 212. For example, if customer 202 asks about the subrogation clause, but asks if it can be removed, AI agent 212 may pause the presentation to answer the question (e.g., “No, that is a requirement from the state insurance commission.”). It should be appreciated that a known answer may refer to the knowledge of how to answer a question, rather than an answer to the question itself (e.g., “I'm not sure. Would you like me to connect you to the legal department? They should be able to answer that question.”).

In another embodiment, AI agent 212 may provide real-time fact checking of what agent 206 is saying. For example, if agent 206 misstates a fact, AI agent 212 may provide a text message to agent communication device 204 and/or whisper chat (i.e., that customer 202 does not hear) that identifies the misstated fact and/or provides the correct information. Server 208 may then continue to monitor the communication to determine if agent 206 corrected the fact and, if not, re-remind agent 206 and/or send a notification to another device, such as a supervisor device.

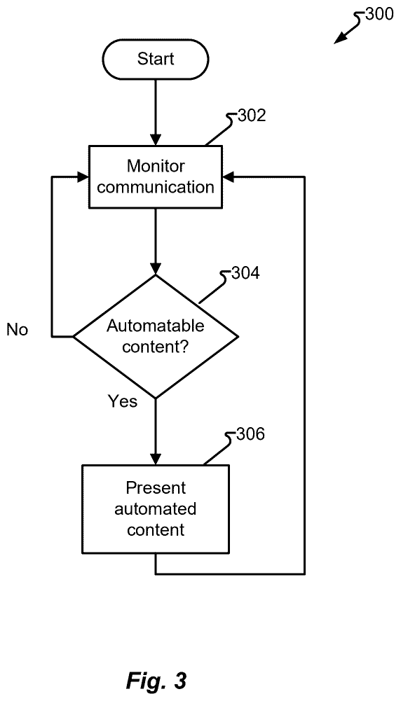

FIG. 3 depicts process 300 in accordance with embodiments of the present disclosure. In one embodiment, process 300 is embodied as machine-readable instructions maintained in a non-transitory memory that when read by a machine, such as processor(s) of a server, cause the machine to execute the instructions and thereby execute process 300. The processor of the server may include, but is not limited to, at least one processor of server 208.

Process 300 begins and, in step 302, monitors the communication. Monitoring may comprise a server (e.g., server 208) monitoring the speech, text, facial expressions, gestures, posture, etc., of customer 202 for communication content (e.g., words, phrases, expressions, etc.) that indicate automatable content. Test 304 determines if automatable content is present, or about to become present, and if test 304 is determined in the affirmative, processing continues to step 306 wherein the automated content is presented. If test 304 is determined in the negative, or upon step 306 completing, processing continues back to step 302. Process 300 may not have a set end and instead may continue until the communication terminates.

The determination of automatable content and providing the automatable content (e.g., automated content) are each variously embodied. One or both of automatable content and providing the automatable content may be performed by providing the communication to AI agent 212. AI agent 212 may be a trained AI, such as a neural network trained to identify automatable content and/or training to provide automated content. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive. In another embodiment, AI agent 212 may be an untrained AI, such as a large language model, which is provided with a prompt comprising the communication, example communications compromising known automatable content and/or examples of communications absent known automatable content, and a request to identify the, or any, automatable content from the communication.

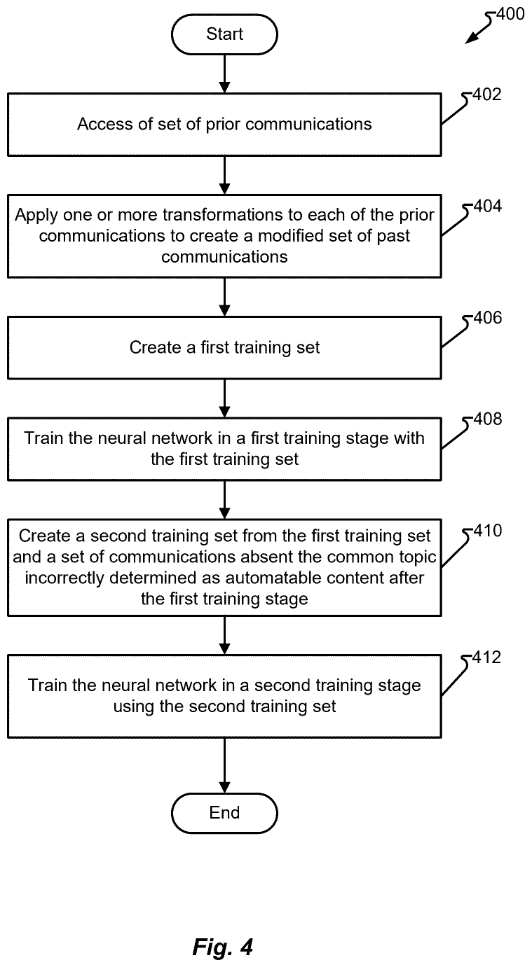

FIG. 4 depicts process 400 in accordance with embodiments of the present disclosure. In one embodiment, process 400 is embodied as machine-readable instructions maintained in a non-transitory memory that when read by a machine, such as processor(s) of a server, cause the machine to execute the instructions and thereby execute process 400. The processor of the server may include, but is not limited to, at least one processor of server 208.

Process 400 begins and, in step 402, accesses a set of prior communications. Step 404 applies one or more transformations to each prior communication of the set of prior communications including adding banter, removing banter, replacing a word with a synonym, increasing spoken volume, decreasing spoken volume, increasing rate of speech, decreasing the rate of speech, adding emotional vocal intonations, removing emotional vocal intonations, inserting a question, and removing a question to create a modified set of prior communications.

Step 406 creates a first training set comprising the collected set of prior communications, the modified set of prior communications, and a set of non-automatable content. Step 408 trains the neural network in a first stage of training using the first training set. Step 410 creates a second training set for a second stage of training comprising the first training set and non-automatable content incorrectly determined as automatable content after the first stage of training and step 412 trains the neural network in the second stage of training using the second training set.

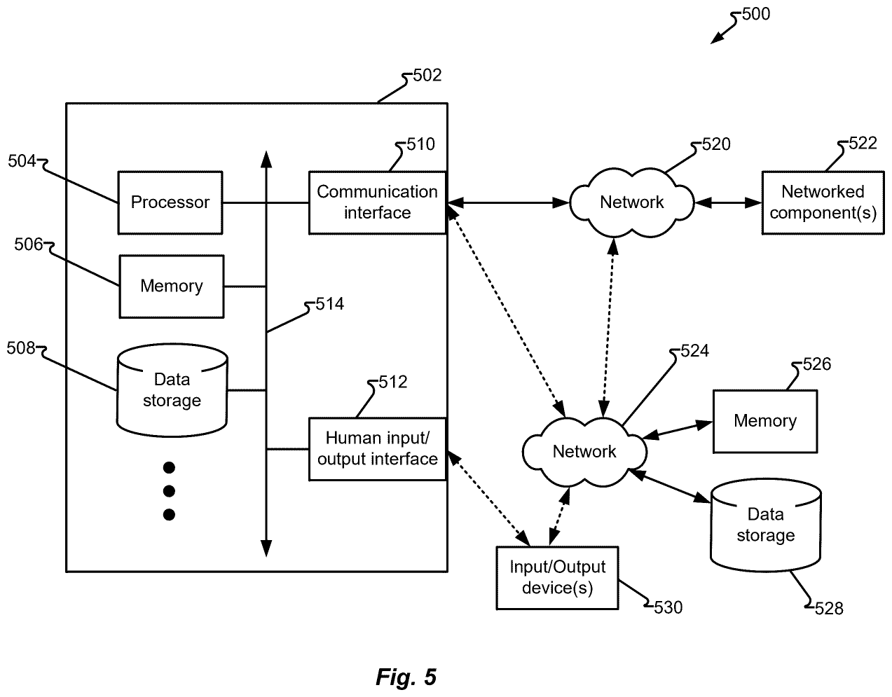

FIG. 5 depicts system 500 in accordance with embodiments of the present disclosure. In one embodiment, server 208 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 104 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, such as contact center 102, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. For example, a connection between one particular customer, using a particular customer communication device 108, may be enabled (or disabled) with a particular networked component 522 and/or particular resource 112. Similarly, one particular networked component 522 and/or resource 112 may be enabled (or disabled) from communicating with a particular other networked component 522 and/or resource 112, including, in certain embodiments, device 502 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-STM microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
monitoring, by a microprocessor, a communication, via a network, between a customer device and an agent device comprising communication content, the communication content further comprising an agent portion provided by an agent via the agent device and a customer portion provided by a customer via the customer device;
upon determining, by the microprocessor monitoring the communication, that the communication comprises automatable content, generating automated content; and
presenting the automated content as the agent portion of the communication to the customer.

2. The method of claim 1, wherein determining that the communication comprises the automatable content further comprises determining that the communication comprises offensive content within the customer portion of the communication.

3. The method of claim 2, further comprising:
accessing a number of records, wherein at least one of the number of records maintains attributes of the agent; and
wherein determining that the communication comprises the offensive content within the customer portion of the communication further comprises determining that at least one of the attributes of the offensive content exceeds at least one of the attributes of the agent.

4. The method of claim 1, wherein determining that the communication comprises the automatable content further comprises determining that the communication comprises offensive content for the agent.

5. The method of claim 1, wherein generating automated content comprising speech attributes of the agent further comprises generating automated content comprising speech attributes of one of the agent or another agent different from the agent.

6. The method of claim 1, wherein determining that the communication comprises the automatable content further comprises providing the communication to a neural network trained to determine the automatable content.

7. The method of claim 6, wherein the neural network is trained, comprising:
collecting a set of prior communications from a database;
applying one or more transformations to each prior communication of the set of prior communications, including adding banter, removing the banter, replacing a word with a synonym, increasing spoken volume, decreasing the spoken volume, increasing rate of speech, decreasing the rate of speech, adding emotional vocal intonations, removing the emotional vocal intonations, inserting a question, and removing the question to create a modified set of prior communications;
creating a first training set comprising the collected set of prior communications, the modified set of prior communications, and a set of non-automatable content;
training the neural network in a first stage of training using the first training set;
creating a second training set for a second stage of training comprising the first training set and non-automatable content incorrectly determined as automatable content after the first stage of training; and
training the neural network in the second stage of training using the second training set.

8. The method of claim 1, wherein determining that the communication comprises the automatable content further comprises:
generating a prompt comprising the communication, a set of prior communications comprising automatable content, a set of prior communications comprising non-automatable content, and a request to identify automatable content in the communication; and
providing the prompt to an artificial intelligence and receiving the automatable content therefrom.

9. The method of claim 1, wherein presenting the automated content as the agent portion of the communication to the customer further comprises muting, by the microprocessor, an audio input portion of the agent device that receives speech from the agent.

10. The method of claim 1, further comprising:
a database comprising a document record; and
wherein generating automated content further comprises generating a script comprising the document record.

11. The method of claim 10, wherein:
the database further comprises a customer attribute of the customer; and
the document record further comprises a document record associated with the customer attribute.

12. A system, comprising:
a network interface to a network;
at least one microprocessor coupled to a computer memory comprising instructions that, when read by the microprocessor, cause the microprocessor to perform:
monitoring a communication, via the network, between a customer device and an agent device comprising communication content, the communication content further comprising an agent portion provided by an agent via the agent device and a customer portion provided by a customer via the customer device;
upon determining that the communication comprises automatable content, generating automated content; and
presenting the automated content as the agent portion of the communication to the customer.

13. The system of claim 12, wherein determining that the communication comprises the automatable content further comprises determining that the communication comprises offensive content within the customer portion of the communication.

14. The system of claim 13, further comprising:
a data storage comprising a number of records, wherein at least one of the number of records maintains attributes of the agent; and
wherein the microprocessor further performs:
accessing the number of data records; and
determining that the communication comprises offensive content within the customer portion of the communication further comprises determining that at least one of the attributes of the offensive content exceeds at least one of the attributes of the agent.

15. The system of claim 12, wherein determining that the communication comprises the automatable content further comprises determining that the communication comprises offensive content for the agent.

16. The system of claim 12, wherein generating automated content comprising speech attributes of the agent further comprises generating automated content comprising speech attributes of one of the agent or another agent different from the agent.

17. The system of claim 12, wherein determining that the communication comprises the automatable content further comprises providing the communication to a neural network trained to determine the automatable content.

18. The system of claim 17, wherein the neural network is trained, comprising:
the at least one microprocessor coupled to the computer memory comprising instructions to cause the at least one microprocessor, upon reading the instructions, to perform:
collecting a set of prior communications from a database;
applying one or more transformations to each prior communication of the set of prior communications, including adding banter, removing the banter, replacing a word with a synonym, increasing spoken volume, decreasing the spoken volume, increasing rate of speech, decreasing the rate of speech, adding emotional vocal intonations, removing the emotional vocal intonations, inserting a question, and removing the question to create a modified set of prior communications;
creating a first training set comprising the collected set of prior communications, the modified set of prior communications, and a set of non-automatable content;
training the neural network in a first stage of training using the first training set;
creating a second training set for a second stage of training comprising the first training set and non-automatable content incorrectly determined as automatable content after the first stage of training; and
training the neural network in the second stage of training using the second training set.

19. The system of claim 12, wherein determining that the communication comprises the automatable content further comprises generating a prompt comprising the communication, a set of prior communications comprising the automatable content, a set of prior communications comprising non-automatable content, and a request to identify the automatable content in the communication; and
providing the prompt to an artificial intelligence and receiving the automatable content therefrom.

20. A computer-readable medium comprising instructions to cause a microprocessor to perform:
monitoring a communication, via a network, between a customer device and an agent device comprising communication content, the communication content further comprising an agent portion provided by an agent via the agent device and a customer portion provided by a customer via the customer device;
upon determining that the communication comprises the automatable content, generating automated content; and
presenting the automated content as the agent portion of the communication to the customer.
